(19) United States
(12) Patent Application Publication
(10) Pub. No.: US 2015/0000378 A1
(43) Pub. Date: Jan. 1, 2015

(54) MONITORING A HYDRAULIC FLUID FILTER

(71) Applicant: Vetco Gray Controls Limited, Nailsea (GB)

(72) Inventor: Ian John KENT, Nailsea (GB)

(21) Appl. No.: 14/316,931

(22) Filed: Jun. 27, 2014

(30) Foreign Application Priority Data
Jun. 27, 2013 (GB) 1311407.9

(51) Int. Cl. G01N 15/08

(52) U.S. Cl. CPC G01N 15/0826; G01N 2015/084
USPC 73/38

(57) ABSTRACT

A hydraulic circuit for supplying hydraulic fluid to a subsea control module of a control system for an underwater hydrocarbon well, the hydraulic circuit including an input for hydraulic fluid, a filter connected with the input for filtering hydraulic fluid from the input, an output for supplying hydraulic fluid from the filter to the subsea control module, first sensing means for sensing pressure of hydraulic fluid from the input upstream of the filter, second sensing means for sensing pressure of hydraulic fluid downstream of the filter, and a subsea electronics module in the subsea control module, the subsea electronics module being coupled with the first and second sensing means and being adapted to produce an indication related to a hydraulic fluid pressure differential across the filter.

### BACKGROUND OF THE INVENTION

Embodiments of the present invention relate to monitoring a hydraulic fluid filter, in particular such a filter in an underwater (for example subsea) well control system.

In offshore hydrocarbon well control systems, the main equipment of a typical system configuration includes: a master control station, which provides the operator interface with subsea equipment and displays the current state of various subsurface equipment, subsea valves and sensor information enabling the operator to control the system; an umbilical cable, which connects the master control station to the equipment installed on the seabed and incorporates a communication link which carries control signals to the subsurface equipment and transfers information on the status of the subsurface equipment to the master control station; a subsea control module, which receives commands from the master control station and controls subsea processes, provides the hydraulic power to actuate valves and transmits status data on subsea equipment and sensor data to the master control station; a subsea electronics module, housed within the subsea control module and which typically is a microprocessor based electronics unit that houses a set of printed circuit boards, the functions of which include communication with the master control station (receiving control information from, and transmitting sensor data to, the master control station), interfacing with subsurface sensors and controlling valves and hydraulics; and a tree installed on the seabed, to which is fitted the subsurface electric and hydraulic equipment needed to control the flow of fluids from or to the well together with a sensor pack, to determine the state of the tree equipment, well head components and fluid flowing from or to the well.

Hydraulic fluid is supplied to a subsea control module in a redundant manner in order to provide power for operating the hydraulic valves located on subsea trees and manifolds.

In order to remove particulate matter from the fluid, the fluid is passed through filters. Pressure transducers are normally located downstream of the filters for monitoring the incoming pressure of the fluid, and then selector valves allow the operator to select which of the redundant supplies is used for valve operation. The selected fluid is then used as a common supply for operations within the subsea control module, and a pressure transducer is used to monitor this supply pressure.

FIG. 1 shows a typical schematic for one of the supplies to a subsea control module. Hydraulic fluid is supplied in a redundant manner from supplies A and B via inputs la and lb and each incoming supply is filtered to remove particulate matter by a respective one of filters 2a and 2b. Then the fluid is passed to respective ones of selector valves 4a and 4b, enabling supply selection to be performed, and a common supply to an output 5 is provided via a shuttle valve 6. The pressure of hydraulic fluid downstream of the filters is monitored by respective ones of pressure transducers 7a and 7b and the pressure of the common supply is monitored downstream of the shuttle valve 6 by a pressure transducer 8. The common supply from output 5 is fed to a manifold 9 within the subsea control module.

With this configuration of transducers and filters, there is no method to monitor the health (contamination levels) and hence life of the filters.

If there is no method for assessing the contamination of such filters when a subsea control module is deployed and the subsea control module is operated until problems are experienced, if the filters become blocked, this could result in the well being shut in, and cause lack of hydrocarbon production for a period of time until the module can be recovered and a replacement installed.

### SUMMARY OF THE INVENTION

According to an embodiment of the present invention, there is provided a hydraulic circuit for supplying hydraulic fluid to a subsea control module of a control system for an underwater hydrocarbon well, comprising: an input for hydraulic fluid; a filter connected to the input for filtering hydraulic fluid from the input; an output for supplying hydraulic fluid from the filter to the subsea control module; first sensing means for sensing pressure of hydraulic fluid from the input upstream of the filter; second sensing means for sensing pressure of hydraulic fluid downstream of the filter; and a subsea electronics module in the subsea control module, the subsea electronics module being coupled with the first and second sensing means and being adapted to produce an indication related to a hydraulic fluid pressure differential across the filter.

There could be at least one further such subsea electronics module in the subsea control module for redundancy purposes, the or each further subsea electronics module also being coupled with the first and second sensing means.

In an embodiment, the circuit includes: a further input for hydraulic fluid and a further filter, connected to the further input for filtering hydraulic fluid from the further input, the output being connected for use in supplying hydraulic fluid from the further filter to the subsea control module; means for selecting whether the output supplies hydraulic fluid to the subsea control module from the first or the further filter; and further such first sensing means, for sensing pressure of hydraulic fluid from the further input upstream of the further filter, the second sensing means sensing pressure of hydraulic fluid downstream of the further filter, the or each subsea electronics module being coupled with the further such first sensing means and being adapted to produce an indication related to a hydraulic fluid pressure differential across that one of the first and further filters which is supplying fluid to the output.

In this case, the first and further such first sensing means could comprise respective ones of transducers between the first and further filters and the first and further inputs.

The second sensing means could comprise a transducer between such selecting means and the output. Alternatively, the second sensing means could comprise respective ones of transducers between outputs of the first and further filters and such selecting means.

According to an embodiment of the present invention, there is provided a method of monitoring a filter in a hydraulic circuit for supplying hydraulic fluid to a subsea control module of a control system for an underwater hydrocarbon well, the circuit comprising: an input for hydraulic fluid; a filter connected to the input for filtering hydraulic fluid from the input; and an output for supplying hydraulic fluid from the filter to the subsea control module, wherein the method comprises: sensing pressure of hydraulic fluid from the input upstream of the filter; sensing pressure of hydraulic fluid downstream of the filter; and using software algorithms within a subsea electronics module in the subsea control module to produce an indication related to a hydraulic fluid pressure differential across the filter, the subsea electronics module being coupled with the first and second sensing means.

In an embodiment, the circuit includes a further input for hydraulic fluid and a further filter, connected to the further input for filtering hydraulic fluid from the further input, the output being connected for use in supplying hydraulic fluid from the further filter to the subsea control module, the method comprising: selecting whether the output supplies hydraulic fluid to the subsea control module from the first or the further filter; and sensing pressure of hydraulic fluid upstream of the filter supplying hydraulic fluid to the output and sensing pressure of hydraulic fluid downstream of the that filter, the subsea electronics module being adapted to produce an indication related to a hydraulic fluid pressure differential across that one of the first and further filters which is supplying hydraulic fluid to the output.

By evaluating the rate of change of differential pressure over time, predictive maintenance may be performed.

### BRIEF DESCRIPTION OF THE DRAWINGS

FIG. 1 is a schematic diagram of a known form of hydraulic fluid supply circuit for a subsea control module;

FIG. 2 is a schematic diagram of a first embodiment of a hydraulic fluid supply circuit for a subsea control module according to the present invention; and

FIG. 3 is a schematic diagram of a second embodiment of a hydraulic fluid supply circuit for a subsea control module according to the present invention.

### DETAILED DESCRIPTION

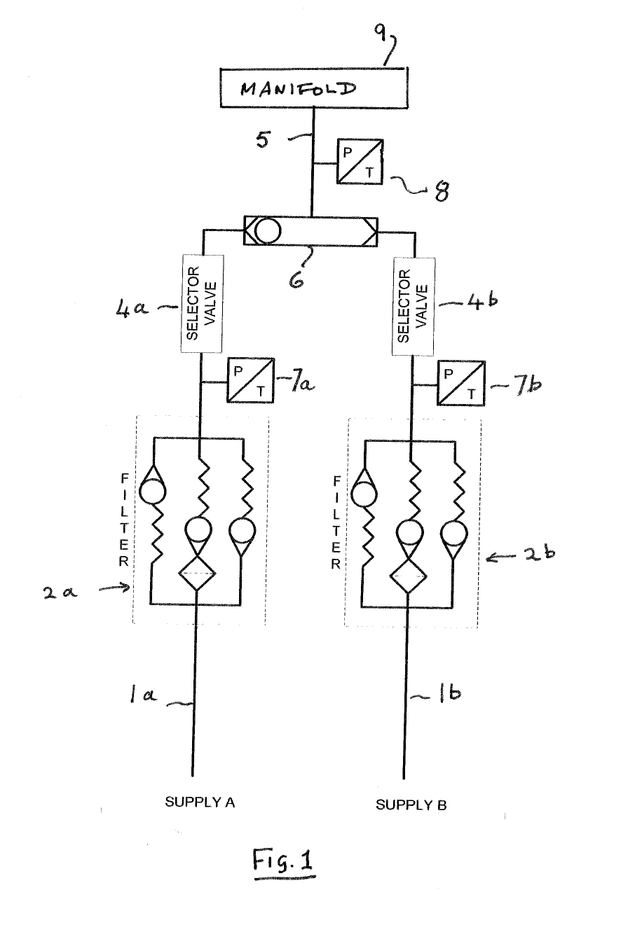

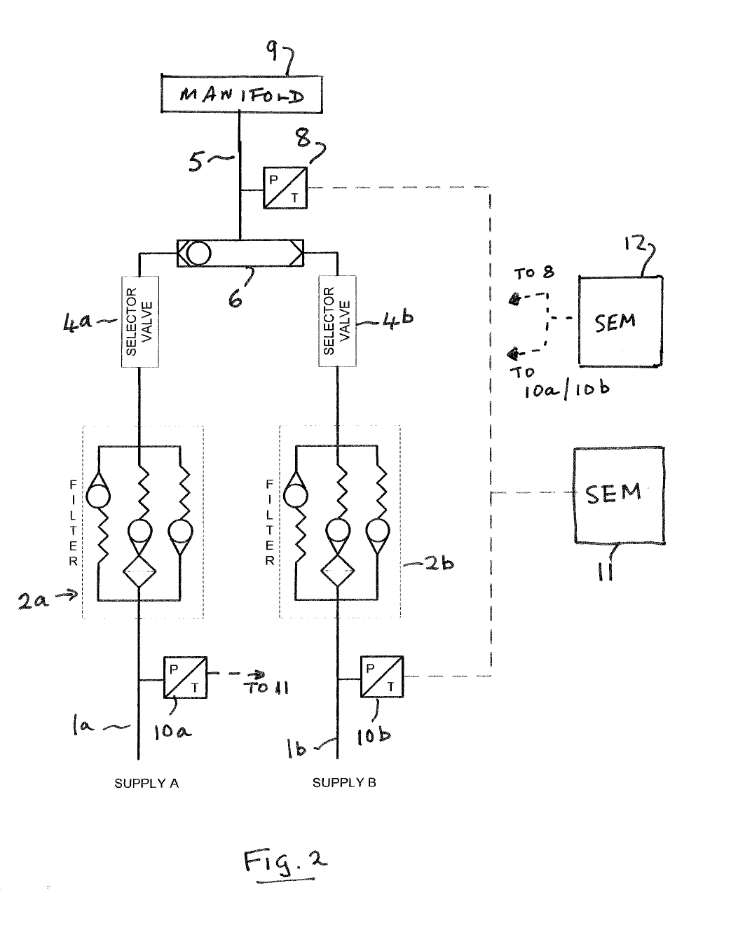

If the hydraulic circuit of FIG. 1 is modified such that the pressure transducers monitoring the incoming supplies are located upstream of the filters, then a method of implying the contamination levels of the filters may be realised. This configuration is shown in FIG. 2, in which items which correspond with items in FIG. 1 have the same reference numerals as in FIG. 1.

In FIG. 2, pressure transducers 7a and 7b have been omitted, the input supplies of filters 2a and 2b are monitored by respective ones of upstream pressure transducers 10a and 10b, and transducer 8 and transducers 10a and 10b are coupled with a subsea electronics module (SEM) 11 in the subsea control module.

With the hydraulic circuit modified as per FIG. 2, by monitoring the differential pressure (using subsea electronics module 11) between the transducer 8 downstream of the shuttle valve 6, and the pressure upstream of that filter whose output is selected (as sensed by the respective one of transducers 10a and 10b), the contamination level of that filter may be estimated.

Filter health monitoring using differential pressure sensing is known using a dedicated physical differential pressure sensor across the filter. However, this application uses normal pressure transducers which can exist in the circuit, and software algorithms in the subsea electronics module to implement an active monitoring system. The subsea electronics module software is configured to monitor the hydraulic pressure transducer 8 downstream of the shuttle valve and the hydraulic pressure transducer 10a or 10b upstream of the filter synchronously so that their digitised signals represent the pressures at the same point in time. By then subtracting the downstream pressure from the upstream pressure, a virtual differential pressure sensor is realised. As the differential pressure function is calculated through software, other calibration factors may be applied such as correcting for incoming supply pressure fluctuations.

As a filter becomes blocked, the differential pressure across it becomes higher. Since in use of the hydraulic circuit, flow is only sporadic (during and after valve operations), when the system is in steady state, no differential would exist, so the software within the subsea electronics module is configured to monitor the peak differential pressure during each active period. When the differential pressure exceeds a threshold during a period of fluid flow, an alarm can be raised, thus alerting the operator of a potential blockage within the filter.

It should be noted from FIG. 2 that there are other components than filters in the flow path between each input and the output (selector valves and shuttle valve). These components may affect flow, and as such affect the differential pressure measured. However these devices can be considered constants, and their effect zeroed out of the calculated differential pressure through taking baseline readings when the filter is known to be clean.

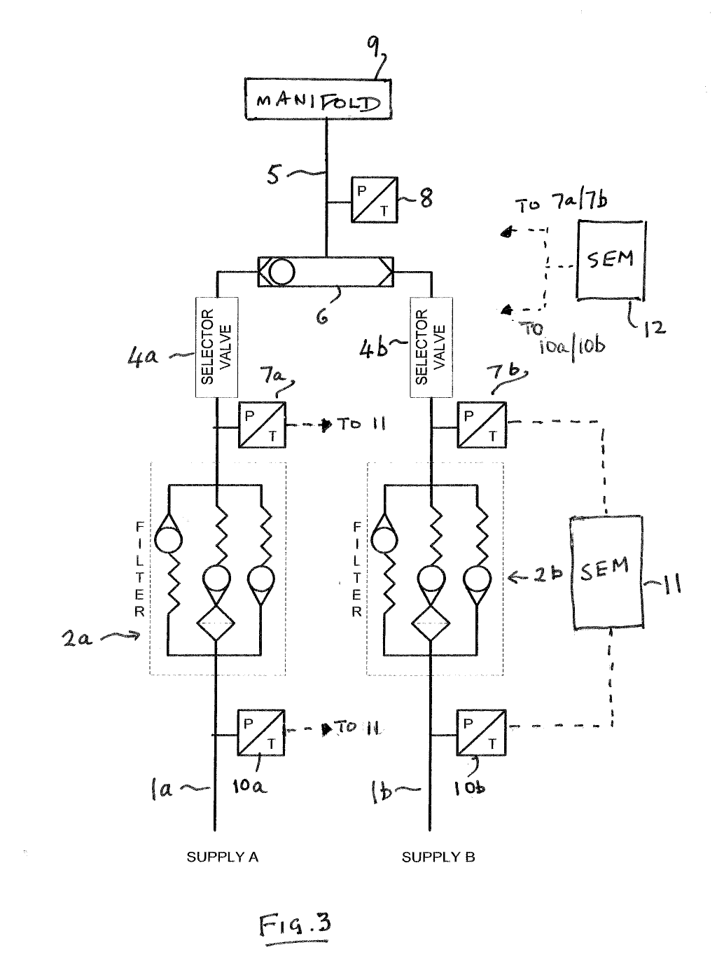

A further improvement of the hydraulic circuit (at the expense of additional pressure transducers) may be realised as shown in FIG. 3, in which items which correspond with those in FIGS. 1 and 2 have the same reference numerals as in FIGS. 1 and 2. In FIG. 3, transducers 7a or 7b are included, the subsea electronics module 11 monitoring the pressure differential between transducer 7a or 7b and transducer 10a or 10b as the case may be, depending on which of filters 2a and 2b is supplying hydraulic fluid to the output 5.

This configuration allows absolute monitoring of the filters without the potential for differential pressure inaccuracy due to the other components in the flow path.

In each of the embodiments of FIGS. 2 and 3 at least one further such subsea electronics module 12 could be included in the subsea control module for redundancy purposes, one of them being used as appropriate.

The or each further module 12 is coupled with transducers 8 and 10a and 10b in the case of FIG. 2 and with transducers 7a and 7b and 10a and 10b in the case of FIG. 3.

As the differential pressure that will be monitored is an analogue reading, over time a rate of change can therefore be determined. This rate of change can then be used to predict when maintenance and intervention may be required.

Embodiments of the present invention enable the contamination levels of the filters within a subsea control module to be assessed whilst the module is in operation, enables the operator to be alerted of contamination, and enables maintenance of the module to be scheduled

If a method of assessing the contamination level within the filters during operation can be implemented, then subsea control module operation may be optimised, or preventative maintenance planned thus alleviating unscheduled shutdowns and loss of production.

By adding little specific hardware into the subsea control module, a predictive method for identifying progressive contamination of hydraulic filters can be achieved.

This will allow enhanced subsea control module prognostics, and planning predictive replacement of such a module in the event of filter contamination.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A hydraulic circuit for supplying hydraulic fluid to a subsea control module of a control system for an underwater hydrocarbon well, the hydraulic circuit comprising:
at least one input for supplying the hydraulic fluid;
at least one filter connected to the at least one input for filtering the hydraulic fluid from the at least one input;
an output configured to supply the hydraulic fluid from the at least one filter to the subsea control module;
at least one upstream sensor configured to sense a pressure of the hydraulic fluid from the at least one input upstream of the at least one filter;
a downstream sensor configured to sense a pressure of the hydraulic fluid downstream of the at least one filter; and
at least one subsea electronics module in the subsea control module, wherein the at least one subsea electronics module is coupled with the at least one upstream sensor and the downstream sensor, and is configured to produce an indication related to a hydraulic fluid pressure differential across the at least one filter.

2. The hydraulic circuit according to claim 1, wherein the at least one subsea electronics module comprises at least two subsea electronics module in the subsea control module for redundancy purposes, and each of the at least two subsea electronics module is coupled with the at least one upstream sensor and the downstream sensor.

3. The hydraulic circuit according to claim 1, wherein:
the at least one input comprises a first input and a second input,
the at least one filter comprises a first filter and a second filter, wherein the first filter is connected to the first input for filtering the hydraulic fluid from the first input, and the second filter is connected to the second input for filtering the hydraulic fluid from the second input,
the at least one upstream sensor comprises a first upstream sensor and a second upstream sensor, wherein the first upstream sensor is configured to sense a pressure of the hydraulic fluid from the first input upstream of the first filter, and the second upstream sensor is configured to sense a pressure of the hydraulic fluid from the second input upstream of the second filter,
the hydraulic circuit further comprises a controller configured to select supplying the hydraulic fluid to the subsea control module from one of the first filter and the second filter, and
the subsea control module is coupled with the first upstream sensor and the second upstream sensor, and is further configured to produce an indication related to a hydraulic fluid pressure differential across the one of the first filter and the second filter.

4. The hydraulic circuit according to claim 3, wherein each of the first upstream sensor and the second upstream sensor comprises a transducer between the respective input and the respective filter.

5. The hydraulic circuit according to claim 3, wherein the downstream sensor comprises a transducer between the controller and the output.

6. The hydraulic circuit according to claim 3, wherein the downstream sensor comprises a transducer between each of the first filter and the second filter and the controller.

7. The hydraulic circuit according to claim 4, wherein the downstream sensor comprises a transducer between the controller and the output.

8. The hydraulic circuit according to claim 4, wherein the downstream sensor comprises a transducer between each of the first filter and the second filter and the controller.

9. A method of monitoring a filter in a hydraulic circuit for supplying hydraulic fluid to a subsea control module of a control system for an underwater hydrocarbon well, wherein the hydraulic circuit comprises an input for supplying the hydraulic fluid, a filter connected with the input for filtering the hydraulic fluid from the input, and an output configured to supply the hydraulic fluid from the filter to the subsea control module, the method comprising:
sensing a pressure of the hydraulic fluid from the input upstream of the filter;
sensing a pressure of the hydraulic fluid downstream of the filter; and
producing an indication related to a hydraulic fluid pressure differential across the filter, the subsea electronics module being coupled with the first and second sensing means.

10. The method according to claim 9, wherein the hydraulic circuit further comprises a further input for the hydraulic fluid and a further filter, connected to the further input for filtering the hydraulic fluid from the further input, and the output is further configured to supply the hydraulic fluid from the further filter to the subsea control module, the method further comprising:
selecting whether the output supplies the hydraulic fluid to the subsea control module from one of the filter and the further filter;
sensing the pressure of the hydraulic fluid upstream of the one of the filter and the further filter supplying the hydraulic fluid to the output;
sensing the pressure of the hydraulic fluid downstream of the one of the filter and the further filter supplying the hydraulic fluid to the output; and
producing an indication related to a hydraulic fluid pressure differential across the one of the filter and the further filter supplying the hydraulic fluid to the output.
